(19) United States
(12) Patent Application Publication
(10) Pub. No.: US 2009/0000881 A1
(43) Pub. Date: Jan. 1, 2009

(54) Disc Brake for a Commercial Vehicle

(75) Inventor: Franz GASSLBAUER, Johanniskirchen (DE)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme fuer Nutzfahrzeuge GmbH, Muenchen (DE)

(21) Appl. No.: 12/020,804

(22) Filed: Jan. 28, 2008

Related U.S. Application Data
(63) Continuation of application No. PCT/EP2006/006901, filed on Jul. 14, 2006.

(30) Foreign Application Priority Data
Jul. 26, 2005 (DE) 10 2005 034 868.8

(51) Int. Cl. F16D 65/40

(52) U.S. Cl. 188/71.7

(57) ABSTRACT

A disc brake is provided for a commercial vehicle, having a brake caliper and brake pads, which make contact with a brake disc. At least one brake pad, together with a carrier plate and a friction lining fixed on the latter, can be pressed against the brake disc by a brake application device via at least one rotatable control spindle and a pressure piece which is operatively connected to the latter and is connected fixedly to the carrier plate. A folding bellows, which is fastened such that it cannot rotate to the brake caliper and bears freely for the unimpeded rotation of the control spindle and yet in a sealing manner against said control spindle, is provided for sealing the outlet region of the control spindle out of the brake caliper.

### CROSS-REFERENCE TO RELATED APPLICATIONS

This application is a continuation of PCT International Application No. PCT/EP2006/006901, filed on Jul. 14, 2006, which claims priority under 35 U.S.C. §119 to German Application No. 10 2005 034 868.8, filed Jul. 26, 2005.

### BACKGROUND AND SUMMARY OF THE INVENTION

The invention relates to a disc brake for a commercial vehicle having a brake caliper engaging over a brake disc and having brake pads which make contact with the brake disc in the functional position. At least one brake pad, can be pressed, together with a carrier plate and a friction lining fixed thereon, against the brake disc by way of a brake application device via at least one rotatable adjusting spindle and a pressure piece, which is in operative connection with the adjusting spindle and is connected fixedly to the carrier plate.

A similar disc brake is known from German patent document DE 103 02 334 A1. This design, in which the pressure pieces are connected fixedly to the carrier plate, preferably by way of a one-piece embodiment with the carrier plate, has proved appropriate in principle.

However, DE 103 02 334 A1 provides no indication of how to seal the exit region of the adjusting spindle from the brake caliper.

Although German patent document DE 195 15 063 C2 discloses the arrangement of a bellows for sealing the exit region of the adjusting spindle, here the assigned pressure piece is connected to the adjusting spindle, that is to say, it can likewise be rotated in a manner corresponding to the rotation of the adjusting spindle. On the one hand, this results in sealing problems between the bellows, which is connected fixedly to the brake caliper, and the pressure piece which can be rotated with respect thereto. The installation of the bellows, in particular its connection to the pressure piece, is also complicated and costly. Problems additionally arise both during pre-assembly and during transport of the disc brake.

In addition, the known disc brakes each have a brake application device having two adjusting spindles which are displaceably mounted in the brake caliper and at whose ends facing the brake disc is arranged a respective pressure piece, wherein the brake pad makes contact, in an operating situation, with the brake disc by way of the pressure pieces.

The invention develops a disc brake of the above-described type such that it can be produced in a more cost-effective manner and can be transported more easily.

According to the invention, a disc brake is provided for a commercial vehicle having a brake caliper engaging over a brake disc and having brake pads which make contact with the brake disc in the functional position. At least one brake pad, can be pressed, together with a carrier plate and a friction lining fixed thereon, against the brake disc by way of a brake application device via at least one rotatable adjusting spindle and a pressure piece, which is in operative connection with the adjusting spindle and is connected fixedly to the carrier plate. In order to seal the exit region of the adjusting spindle from the brake caliper, a bellows is provided. The bellows is fastened in a rotationally fixed manner to the brake caliper and, for the unimpeded rotation of the adjusting spindle, bears freely but in a seal forming fashion against the adjusting spindle.

This structural design closes off the exit region of the adjusting spindle and/or the resulting opening in the brake caliper without including the pressure piece.

By way of an axially secured, but, as it were, radially loose, connection of the bellows to the adjusting spindle, the adjusting spindle can be rotated freely, in order, for example, to set a predetermined degree of air play between the brake disc and the brake lining via an adjustment device. For this purpose, the adjusting spindle is embodied as a threaded spindle, which is screwed into an inner thread of a crossmember of the brake caliper.

In this case, the bellows can be connected fixedly and directly to the brake caliper in a manner known per se, for example by pressing-in, but also to a closure plate which closes off an installation opening in the brake caliper but has an exit opening for the adjusting spindle.

In any case, the invention permits industrial pre-assembly, which prevents the transport problems which have arisen previously.

Dispensing with the connection of the bellows to the pressure piece is also an improvement which contributes, in particular, to simpler production and a reduction in costs. This is particularly notable because disc brakes are produced as serial components in large numbers.

In addition to cost reduction and improved assembly, the invention brings about a desired weight reduction compared to the solutions according to the prior art.

According to one advantageous development of the invention, provision is made for the bellows to have a cap which covers the end side of the adjusting spindle. This results in providing a hermetic seal without special sealing measures being required in the connection region to the adjusting spindle. This cap may be embodied in one piece with the bellows. In particular, with regard to simplified production, however, the two-piece embodiment is particularly advantageous, that is to say the cap is otherwise connected as a separate part to the bellows, preferably in a form-fitting manner.

The cap can be axially fixed by way of a bead, which is oriented radially inward, extends at least over a circumferential subregion, and is produced by appropriate shaping of the cap. The bead engages in an at least partially circumferential annular groove in the adjusting spindle. The annular groove, however, ensures free rotatability of the adjusting spindle with respect to the bellows and the cap.

Further advantageous refinements of the invention are described and claimed herein.

### BRIEF DESCRIPTION OF THE DRAWINGS

An exemplary embodiment of the invention is described below with reference to the accompanying drawings, in which:

FIG. 1 shows a partial illustration of a disc brake in a cut plan view; and

FIG. 2 shows a detail of the disc brake in a longitudinal section.

### DETAILED DESCRIPTION OF THE DRAWINGS

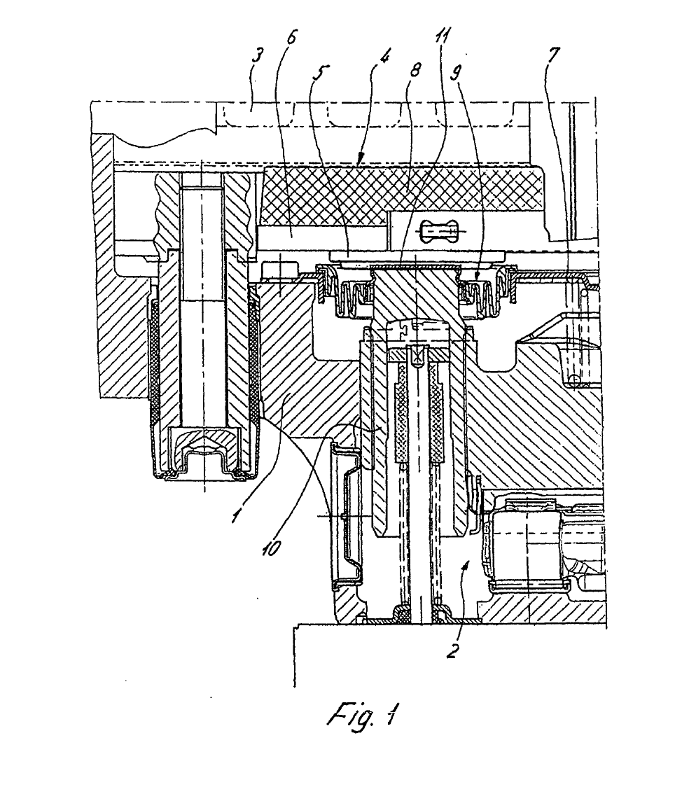

FIG. 1 illustrates one half of a disc brake, which has a brake caliper 1 in the form of a sliding caliper. An upper circumferential region of the caliper straddles a brake disc 3. The disc brake can be actuated pneumatically or electromotively, here.

Brake pads 4 are arranged on both sides of the brake disc 3, one brake pad being illustrated here. In an operational situation, the brake pad 4 can be pressed against the brake disc 3.

The brake pad 4 includes a carrier plate 6, a friction lining 8 fastened to its side facing the brake disc 3, and two pressure pieces 5 connected fixedly to the carrier plate 6. Only one of the pressure pieces 5 can be seen in FIG. 1.

An adjusting spindle 10 is pressed against the pressure piece 5 and thus against the brake pad 4 by way of a brake application device 2, which is arranged in the brake caliper 1 and is operated by a rotary lever.

In order to set an air play between the friction lining 8 and the brake disc 3 while taking into account the wear of the friction lining method 8, the adjusting spindle 10 (in the form of a threaded spindle) is mounted rotatably in the brake caliper 1 and can be moved by way of an adjustment device (not illustrated).

In the present exemplary embodiment, the side of the brake caliper 1 which faces the brake disc 3 is largely closed off by a closure plate 7, which is pierced in the exit region of the adjusting spindle 10.

In order to seal the exit region of the adjusting spindle 10 from the brake caliper 1, a bellows 9 is provided. The bellows 9 is connected to the closure plate 7 and has a cap 11, which cap overlaps the end side of the adjusting spindle 10 and, practically speaking, forms a bearing surface on the pressure piece 5.

Here, the bellows 9 is connected to the closure plate 7 in a rotationally fixed manner, while the adjusting spindle 10 is mounted in a freely rotatable manner in the bellows 9 which, however, engages in an axially secured manner.

If the brake caliper 1 is embodied in one piece, i.e. when the closure plate 7 is dispensed with, the bellows 9 is fastened directly on the brake caliper 1, preferably by being pressed-in to the caliper.

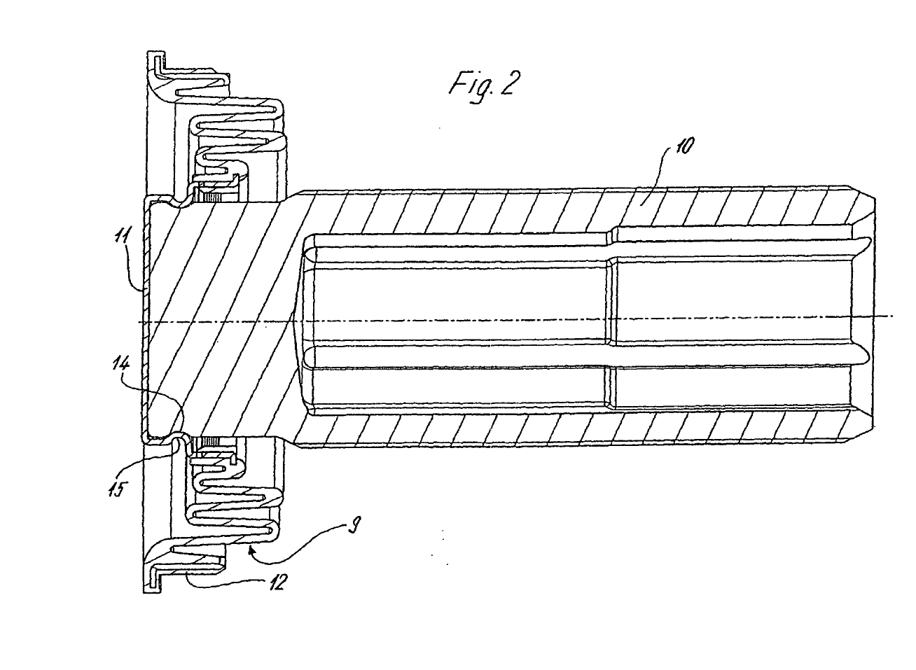

FIG. 2 is an enlarged illustration of the adjusting spindle 10 with the bellows 9 connected thereto.

It can be clearly seen here that the cap 11, which covers the end side of the adjusting spindle 10 and overlaps the associated casing region, and the bellows 9 are embodied in two pieces. A one-piece embodiment is however also contemplated.

The cap 11 has a circulating bead 15, which engages in a form-fitting manner in an annular groove 14 provided in the casing-side overlapping region of the cap 11 in the adjusting spindle 10, and thus axially secures the cap 11 and, therefore, the bellows 9.

The bead 15 and the annular groove 14 are, however, dimensioned in such a way that free rotatability of the adjusting spindle 10 within the cap 11 is ensured.

The outer edge 12 of the bellows 9 is shaped in such a way that pressing with the closure plate 7 or with the brake caliper 1 is possible, so that the bellows 9 is connected fixedly to the brake caliper 1 or to the closure plate 7.

It is contemplated in principle, to connect the cap 11 to the bellows 9 in such a way that it is possible to rotate the cap 11 in relation to the bellows 9 with the result that, for example when corresponding friction occurs, the cap 11 with the adjusting spindle 10 can be rotated with respect to the bellows 9.

1-7. (canceled)

8. A disc brake for a commercial vehicle having a brake disc, comprising:
a caliper which, in use, straddles over the brake disc;
brake pads which contact the brake disc to perform braking, at least one brake pad comprising a carrier plate and a friction lining fixed on the carrier plate;
a brake application device comprising at least one rotatable adjusting spindle for pressing the at least one brake pad against the brake disc;
a pressure piece operatively coupled with the adjusting spindle and being fixedly connected to the carrier plate;
a bellows operatively arranged to seal an exit region of the adjusting spindle from the brake caliper; and
wherein the bellows is fastened in a rotationally fixed manner to the caliper and bears freely but in a seal forming fashion against the adjusting spindle, whereby rotation of the adjusting spindle is unimpeded by the bellows.

9. The disc brake according to claim 8, wherein the bellows comprises a cap overlapping an end side of the adjusting spindle facing the pressure piece.

10. The disc brake according to claim 9, wherein the cap is shaped to be operatively configured on the adjusting spindle in an axially secured manner.

11. The disc brake according to claim 9, wherein the cap and the bellows are separate components fixedly connected to one another.

12. The disc brake according to claim 10, wherein the cap and the bellows are separate components fixedly connected to one another.

13. The disc brake according to claim 9, wherein the cap and the bellows are formed in one-piece.

14. The disc brake according to claim 10, wherein the cap and the bellows are formed in one-piece.

15. The disc brake according to claim 9, wherein the adjusting spindle comprises:
an at least partially annular groove formed circumferentially around an exterior of the adjusting spindle; and
further wherein the cap comprises a region engaging around a cylindrical surface of the adjusting spindle and comprises an at least partial bead operatively configured to engage in the at least partial annular groove.

16. The disc brake according to claim 10, wherein the adjusting spindle comprises:
an at least partially annular groove formed circumferentially around an exterior of the adjusting spindle; and
further wherein the cap comprises a region engaging around a cylindrical surface of the adjusting spindle and comprises an at least partial bead operatively configured to engage in the at least partial annular groove.

17. The disc brake according to claim 11, wherein the adjusting spindle comprises:
an at least partially annular groove formed circumferentially around an exterior of the adjusting spindle; and
further wherein the cap comprises a region engaging around a cylindrical surface of the adjusting spindle and comprises an at least partial bead operatively configured to engage in the at least partial annular groove.

18. The disc brake according to claim 13, wherein the adjusting spindle comprises:
an at least partially annular groove formed circumferentially around an exterior of the adjusting spindle; and
further wherein the cap comprises a region engaging around a cylindrical surface of the adjusting spindle and comprises an at least partial bead operatively configured to engage in the at least partial annular groove.

19. The disc brake according to claim 15, wherein the cap is coupled to the adjusting spindle in an axially secured and freely rotatable manner via a form fit between the bead and the annular groove.
